(19) United States
(12) Patent Application Publication
(10) Pub. No.: US 2012/0268615 A1
(43) Pub. Date: Oct. 25, 2012

(54) PHOTOGRAPHING METHOD AND APPARATUS THEREFOR USING SPECIAL EFFECTS

(75) Inventors: Hyung-tak CHOI, Suwon-si (KR); O-Hoon KWON, Suwon-si (KR)

(73) Assignee: SAMSUNG ELECTRONICS CO., LTD., Suwon-si (KR)

(21) Appl. No.: 13/357,651

(22) Filed: Jan. 25, 2012

(30) Foreign Application Priority Data
Apr. 22, 2011 (KR) 10-2011-0037988

(51) Int. Cl. H04N 5/232; H04N 5/262

(52) U.S. Cl. 348/211.99; 348/239; 348/240.99; 348/E05.051; 348/E05.042

(57) ABSTRACT

In a photographing apparatus, a user pre-selects a number of special effect modes to be applied to pictures not yet taken. The special effect mode selections are stored as an ordered set of special effect mode indicators. When the pictures are subsequently taken, the special effects are automatically applied in the order they were selected, based on the order reflected in the stored special effect mode indicators.

### CROSS-REFERENCE TO RELATED PATENT APPLICATION

This application claims priority from Korean Patent Application No. 10-2011-0037988, filed on Apr. 22, 2011 in the Korean Intellectual Property Office, the disclosure of which is incorporated herein in its entirety by reference.

### BACKGROUND

1. Field

Methods and apparatuses consistent with exemplary embodiments relate to a photographing method and an apparatus therefor, and more particularly, to a consecutive photographing method and apparatus therefor using special effects.

2. Description of the Related Art

In general, a special effect function or a smart filter function of a camera may allow a toy camera effect such as a vignette effect, a fish-eye effect, a miniature effect, and the like, so that a user may create their own interesting and expressions of emotion.

According to the related art, to use a special effect of an image-capturing apparatus that has a special effect function, a user has to repeat the process of setting the various special effects to be applied, and then capturing an image, whenever the user takes a picture.

Thus, according to the related art, when a user takes a picture using different special effects, it is inconvenient for the user because he has to select and set a new special effect, in a settings menu, each time he takes a picture.

### SUMMARY

Exemplary embodiments provide a method and apparatus for consecutively performing photographing operations by using different special effects, in accordance with previously executed special effect settings, set once before performing the photographing operation.

According to an aspect of an exemplary embodiment, there is provided a photographing method including: receiving selection signals indicating one or more special effect modes to be applied to one or more photographing operations to be carried out, wherein the one or more selection signals are received in a selection order; storing, based on the one or more selection signals, one or more stored special effect mode indicators, wherein each of the one or more stored special effect mode indicators relate to a corresponding one of the one or more special effect modes, and wherein the one or more stored special effect mode indicators are stored in an order based on the selection order of the one or more selection signals; and consecutively performing each of the one or more photographing operations so that, for a current photographing operation of the one or more photographing operations: a next one of the one or more stored special effect mode indicators is used to identify the corresponding one of the one or more special effect modes to be applied; and the corresponding one of the one or more special effect modes to be applied is applied to the current photographing operation.

The photographing method may further include resetting the order of the one or more stored special effect mode indicators.

The photographing method may further include outputting to a display window the corresponding one of the one or more special effect modes to be applied.

The photographing method may further include, after the current photographing operation is performed, displaying an image for capture on a display window, using a next one of the one or more special effect modes indicated by a next one of the one or more stored special effect mode indicators.

After completion of the current photographing operation in which a final one of the one or more stored special effect mode indicators has been used to identify the corresponding one of the one or more special effect modes to be applied, the corresponding one of the one or more special effect modes may be caused to continue to be output to a display window.

The current photographing operation may capture an image in accordance with the corresponding one of the special effect modes to be applied, in response to receiving a photographing signal, and the photographing signal may be generated from a photographing button operation.

The photographing signal may be generated from a remote controller.

The photographing signal may be generated when a photographing motion of a user is recognized.

The photographing signal may be generated in response to an indication from a timer that a previously set period of time has elapsed.

The photographing method may further include adjusting for a distance, via zoom-in and zoom-out operations, between the completion of the current photographing operation and a next one of the one or more photographing operations.

The zoom-in and zoom-out operations may be in response to a button manipulation, to a signal received from a remote controller, or a motion-recognition operation.

According to an aspect of another exemplary embodiment, there is provided a photographing apparatus including an image processor that captures an image, generates image data of the image in accordance with a selected special effect mode, and outputs generated the image data; a display unit that displays the generated image data, and displays an operation control menu; and a control unit that sequentially stores one or more stored special effect mode indicators based on selections made from the operation control menu, and that controls the capturing of future images so as to apply special effect modes based on an order of the one or more stored special effect mode indicators, responsive to a photographing signal.

The photographing signal may be a button signal, a remote-control signal, a timer elapse signal, or a motion-recognition signal.

According to an aspect of another exemplary embodiment, there is provided a photographing apparatus, including a computer readable medium storing a control program that defines a plurality of operations; a control unit that executes the plurality of operations defined by the control program; an image capture unit, under control of the control unit; and special effect modes applicable to captured images. The operations may include: storing a user-selected, ordered set of special effect mode indicators, the order of the special effect mode indicators defining a special effect application order, each of the special effect mode indicators having a correspondence with one of the special effect modes; then after the storing of the indicators, using the image capture unit to capture images, the order in which the images are captured defining an image capture order; wherein each of the images has applied thereto, automatically, a respective one of the special effect modes; wherein the respective one of the special effect modes is determined based on the special effect application order, the image capture order, and the correspondence of the special effect mode indicators with the special effect modes.

The photographing apparatus may further include a display under control of the control unit. Prior to capturing each of the images, the display may display an image capture preview; the image capture preview may be displayed on the display with one of the special effect modes applied; the one of the special effect modes applied to the image capture preview may be selected based on both the special effect application order and the image capture order.

In this photographing apparatus, after each of the ordered set of special effect mode indicators has been used in the capturing of the images, a final one of the ordered set of special effect mode indicators may be automatically used to select a corresponding one of the special effect modes for application to the image capture preview.

In this photographing apparatus, the capture of the images may be carried out in response to photographing signals received in from a button manipulation, a remote control transmission, a motion recognition operation, or an elapse of a period of time set in a timer.

### BRIEF DESCRIPTION OF THE DRAWINGS

The above and other aspects will become more apparent by describing in detail exemplary embodiments with reference to the attached drawings in which:

FIG. 1 is a block diagram of a photographing apparatus according to an exemplary embodiment;

FIG. 2 is a flowchart of a photographing method according to an exemplary embodiment;

FIG. 3 illustrates an example of a special effect selection menu screen on which one or more special effect modes of FIG. 2 are selected;

FIG. 4 is a flowchart of the photographing method of FIG. 2, according to another exemplary embodiment;

FIG. 5 is a flowchart of the photographing method of FIG. 2, according to another exemplary embodiment;

FIG. 6 is a flowchart of the photographing method of FIG. 2, according to another exemplary embodiment; and

FIG. 7 is a flowchart of the photographing method of FIG. 2, according to another exemplary embodiment.

### DETAILED DESCRIPTION

Hereinafter, exemplary embodiments will be described in detail with reference to the attached drawings.

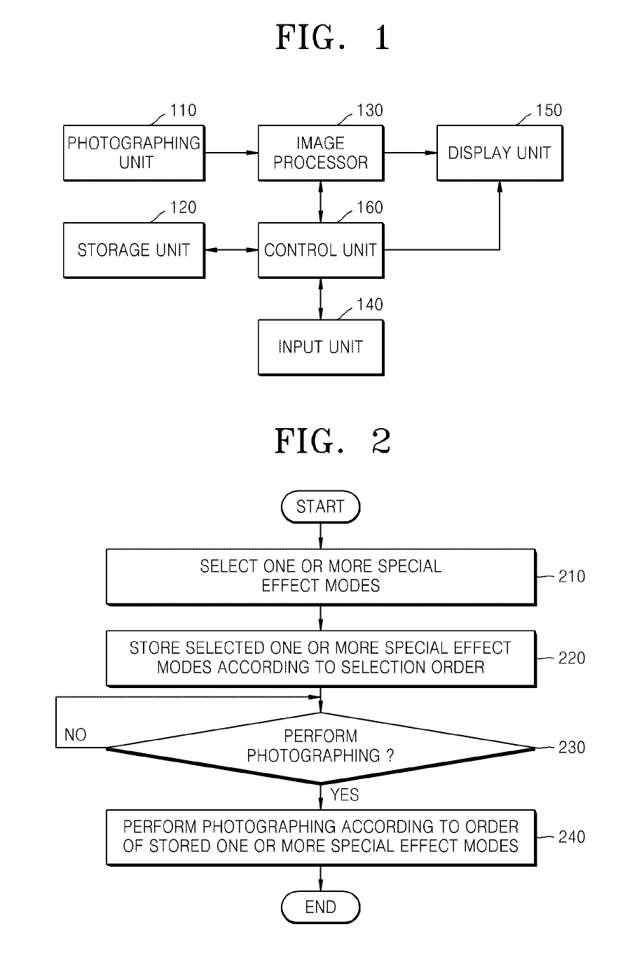

FIG. 1 is a block diagram of a photographing apparatus according to an exemplary embodiment.

A photographing unit 110 captures an image of a target object, and converts the image into a digital image by performing signal processing based on the light intensity of the image formed on a light-receiving surface.

A storage unit 120 may include a magnetic recording medium such as a hard disk drive (HDD), a non-volatile memory such as an electrically erasable programmable read-only memory (EEPROM), a flash memory, or the like. However, the storage unit 120 is not limited thereto. The storage unit 120 may store various programs for carrying out photographing operations, selection menus, and a plurality of special effect modes.

An image processor 130 converts a digital image signal, output from the photographing unit 110, into an image signal to which a selected special effect mode is applied, and then outputs the converted image signal to a display unit 150. Together, the photographing unit 110 and the image processor 130 may be thought of as an image capture unit.

An input unit 140 may have buttons, direction keys, or a combination of these, or a remote controller. However, the input unit 140 is not limited thereto. The input unit 140 outputs functional commands or other inputs to a control unit 160, wherein the functions are indicated by keys or other devices that are manipulated by a user.

The display unit 150 displays the image signal that is output by the image processor 130, and displays various operation control menus that are generated by the control unit 160. The display unit 150 may be a liquid crystal display (LCD), but is not limited thereto.

The control unit 160 receives selection signals indicating one or more special effect modes to be applied to images to be captured, wherein the selection signals are received via the input unit 140 from a user's interaction with the operation control menus displayed on the display unit 150. Then, the control unit 160 sequentially stores the one or more special effect modes selected according to the selection signals in the storage unit 120. Thereafter, whenever a photographing signal is received, the control unit 160 performs photographing operations according to an order of the one or more special effect modes stored in the storage unit 120. Also, whenever a photographing signal is received, the control unit 160 outputs the selected special effect mode to the image processor 130.

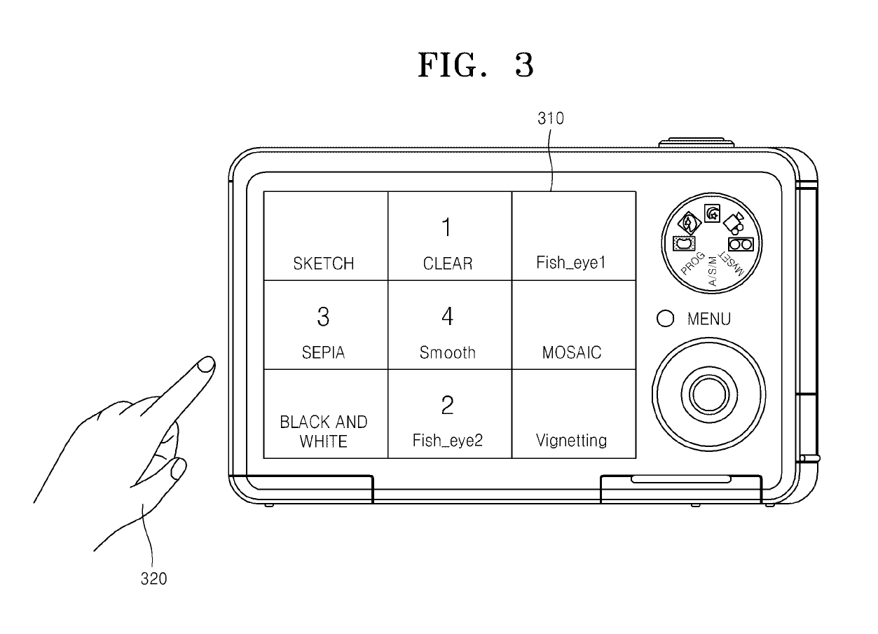

FIG. 2 is a flowchart of a photographing method according to an exemplary embodiment.

First, when a user selects a function menu, a special effect mode selection menu is displayed in a window on display unit 150.

Then, selection signals, that indicate one or more special effect modes that are to be applied to subsequent photographing operations, are received from the special effect mode selection menu (operation 210). That is, a user selects a first special effect mode and a second special effect mode, and possibly additional special effect modes, using the special effect mode selection menu. These selections constitute one or more special effect modes. The selection signals that correspond to these modes may be thought of as one or more corresponding special effect selection signals.

Next, indicators corresponding to the selected one or more special effect modes, are stored in the storage unit 120 (operation 220) in a sequence that reflects the order in which the one or more special effect modes were selected by the user. The stored indicators may be thought of as one or more sequentially stored special effect mode indicators. The one of the indicators that was first selected by the user, and which will consequently be used first, may be understood to be a first one of the one or more sequentially stored special effect mode indicators.

Next, it is checked whether a photographing signal has been received (operation 230). The photographing signal may include, e.g., a button-press signal (resulting, e.g., from the manipulation of a zoom control button), a remote controller signal, motion-recognition, or a timer elapse signal (i.e., a signal generated upon the elapse of a time period indicated by a timer), but is not limited thereto. Also, if necessary, the focus or other settings are adjusted (e.g., if zoom-in or zoom-out operations took place in between a previous photographing operation and the next upcoming photographing operation).

Then, whenever the photographing signal is received, a photographing operation is performed, in response, with a special effect mode that corresponds to the first one of the one or more sequentially stored special effect mode indicators (operation 240).

For example, whenever a camera photographing button signal, a camera remote controller signal, or a user motion-recognition signal is received, the photographing operation is performed according to the order of the stored one or more special effect modes.

After the photographing operation, an image to be captured by using a special effects mode corresponding to the next one of the one or more sequentially stored special effect mode indicators is displayed on the display window.

Whenever the photographing operation is performed, a corresponding special effect mode screen is output to the display window.

In another exemplary embodiment, the order of the one or more sequentially stored special effect mode indicators stored in the storage unit 120 may be reset, and whenever a photographing signal is received, photographing may be consecutively performed according to the reset order of the one or more special effect modes.

According to this exemplary embodiment, when a user previously sets a special effect setting once, before photographing, the user may consecutively perform photographing by using different special effects. Also, by adjusting a distance due to zoom-in and zoom-out operations between taking pictures, the user may perform zoom-adjusted photographing.

Also, the user may perform photographing operations from a remote location, using a display window of a remote controller or motion-recognition, wherein the one or more special effect modes are applied to the display window.

FIG. 3 illustrates an example of a special effect selection menu screen 310 upon which one or more special effect modes, described with reference to FIG. 2, may be selected.

A user 320 selects the one or more special effect modes from the special effect selection menu screen 310. For example, the one or more special effect modes may include a sketch mode, a clear mode, a fish-eye1 mode, a sepia mode, a smooth mode, a mosaic mode, a black and white mode, a fish-eye2 mode, and a vignette mode.

The user 320 may sequentially select one or more modes from among the one or more special effect modes displayed on a screen.

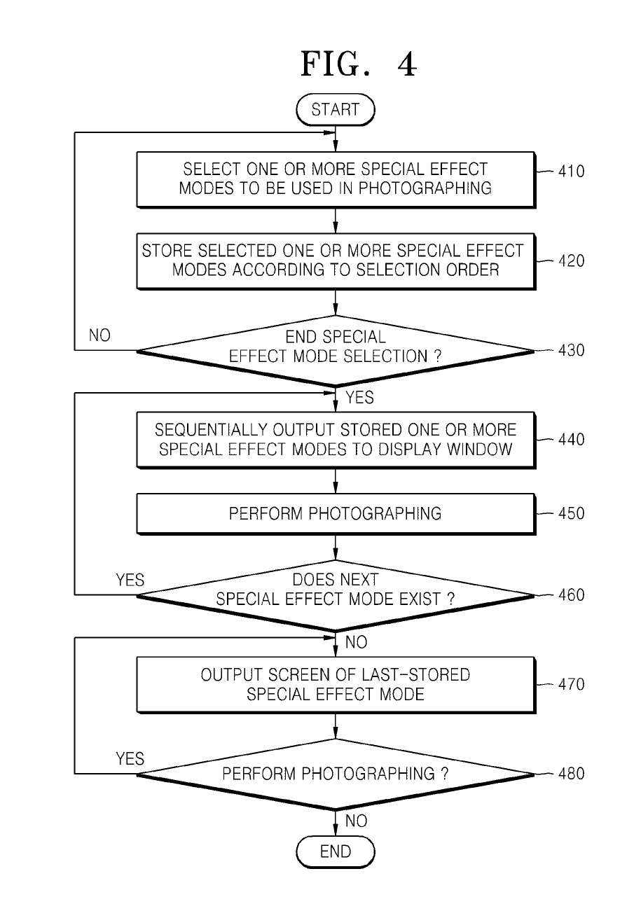

FIG. 4 is a flowchart of the photographing method of FIG. 2, according to an exemplary embodiment.

First, a special effect mode selection menu is displayed in the display window.

Then, one or more special effect modes, to be applied to an image yet to be captured, are selected from the special effect mode selection menu (operation 410).

Then, indicators representing the selected one or more special effect modes are stored in the storage unit 120 in a sequence that reflects the order in which the one or more special effect modes were selected from the special effect mode selection menu (operation 420).

Operation 430 is a check to determine whether the user has finished with selecting special effects.

If the special effect mode selection is not yet complete, operations 410 through 430 are repeated so that additional ones of the one or more special effect mode indicators may be stored in the storage unit 120 according to their selection order.

For example, as illustrated in FIG. 3, it is assumed that the user 320 selects the clear mode first, selects the fish-eye2 mode second, selects the sepia mode third, and selects the smooth mode fourth. Then, the indicators corresponding to the selected special effect modes are stored in the storage unit 120 in the following order, which corresponds to their selection order: the clear mode first, the fish-eye2 mode next, the sepia mode next, and the smooth mode last.

Referring back to FIG. 4, when the selecting of the one or more special effect modes is complete, a screen showing the stored first special effect mode is output to the display window (operation 440), in advance of the receipt of a photographing signal.

Then, when a photographing signal is received, via a photographing button or the like, a picture is taken in accordance with the first special effect mode output to the display window (operation 450).

Then, in operation 460, a determination is made as to whether there exists in the storage a next one of the one or more stored special effect mode indicators.

If the next one of the one or more stored special effect mode indicators exists, operations 440 through 460 are repeated so that the rest of the stored special effect mode indicators are sequentially output to the display window (operation 450), and then photographing operations are consecutively performed and special effects are applied according to the rest of the sequentially stored special effect mode indicators (operation 460).

Returning to the example mentioned above, as illustrated in FIG. 3, when the user 320 presses a photographing operation initiation button, a photographing signal is generated so that a photographing operation is performed in the clear mode that was first stored; when the user 320 again presses the photographing operation initiation button, a photographing operation is performed in the fish-eye2 mode that was secondly stored; when the user 320 again presses the photographing operation initiation button, a photographing operation is performed in the sepia mode that was thirdly stored, and when the user 320 again presses the photographing operation initiation button, a photographing operation is performed in the smooth mode.

Otherwise, if no further stored special effect mode indicators exist, that is to say, all of the one or more sequentially stored special effect mode indicators have been used, the special effect corresponding to the final one of the stored special effect mode indicators is output to the display window (operation 470).

Then, the method involves checking for a further photographing signal (operation 480), and outputs the special effect mode corresponding to the final one of the stored special effect mode indicators to the display window, until photographing is finished.

Accordingly, according to this exemplary embodiment, whenever the photographing button is pressed, images to which the respective special effect modes are applied, may be captured according to the sequential order of the previously selected ones of the special effect modes.

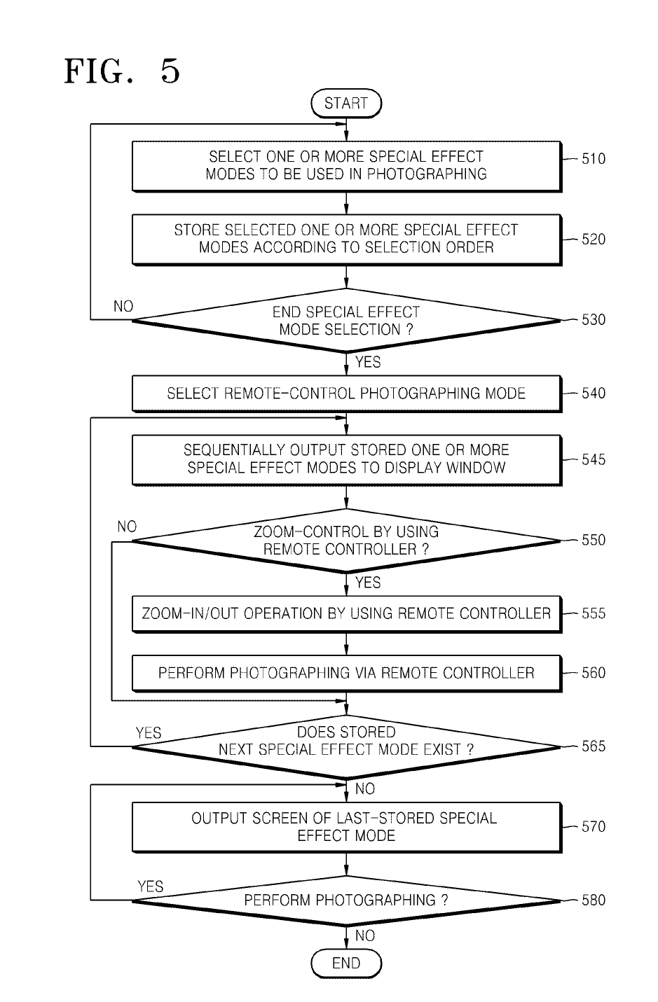

FIG. 5 is a flowchart of the photographing method of FIG. 2, according to another exemplary embodiment.

Operations 510 through 530 are the same as operations 410 through 430 of the method of FIG. 4, and thus, descriptions thereof are not provided.

According to operations 510 through 530, indicators of one or more special effect modes are stored in the storage unit 120 according to the order in which the one or more special effect modes are selected.

Then, a remote-control photographing mode is selected from a photographing menu (operation 540).

When the one or more special effect mode indicators, corresponding to the special effect modes selected by a user, are all stored, a special effect mode corresponding to the first one of the one or more special effect mode indicators is output to a display window (operation 545).

Next is determined whether a zoom control operation has been requested using a remote controller (operation 550).

If the zoom control has been thus performed, corresponding, zoom-in and zoom-out operations are performed by using the remote controller (operation 555).

Then, when a photographing signal is received from the remote controller, a photographing operation is performed using a special effects mode, that corresponds to the first of the stored special effect mode indicators, that is output to the display window (operation 560).

If the zoom control via the remote controller is not performed or a photographing operation is performed using the remote controller, a check is made to determine whether there is a next one of the stored special effect mode indicators (operation 565).

If so, operations 545 through 565 are repeated so that special effect modes corresponding to the rest of the stored special effect mode indicators are sequentially output to the display window (operation 545), and then photographing operations are consecutively performed according to the order in which the rest of the stored special effect mode indicators are stored (operation 560).

For example, as illustrated in FIG. 3, when the user 320 presses a remote-control photographing button, a photographing operation is performed in the clear mode that was first stored; when the user 320 again presses the remote-control photographing button, a photographing operation is performed in the fish-eye2 mode that was stored second; when the user 320 again presses the remote-control photographing button, a photographing operation is performed in the sepia mode that was stored third; and when the user 320 again presses the remote-control photographing button, a photographing operation is performed in the smooth mode.

Otherwise, if there is no next stored special effect mode indicator, a special effect mode corresponding to the last-stored special effect mode is output to the display window (operation 570).

Then, a check is made to determine whether the photographing signal (operation 580) is detected, and the last-stored special effect mode is output to the display window until photographing is finished.

Accordingly, according to the exemplary embodiment, whenever a photographing signal is received from the remote controller, images are captured, each having applied thereto the previously selected respective special effect modes, and the special effect modes are applied in the order in which the user selected them.

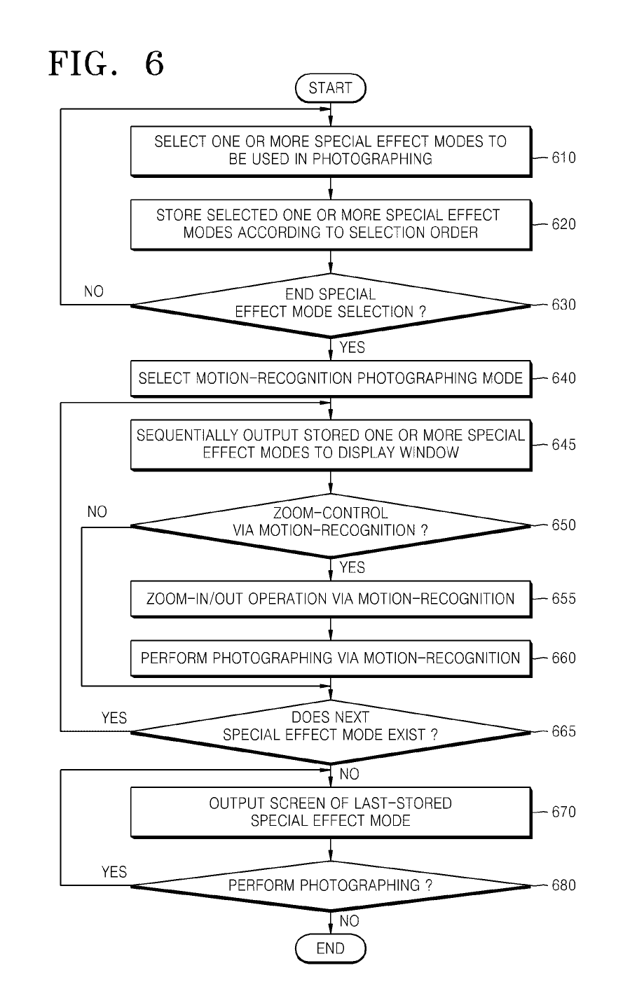

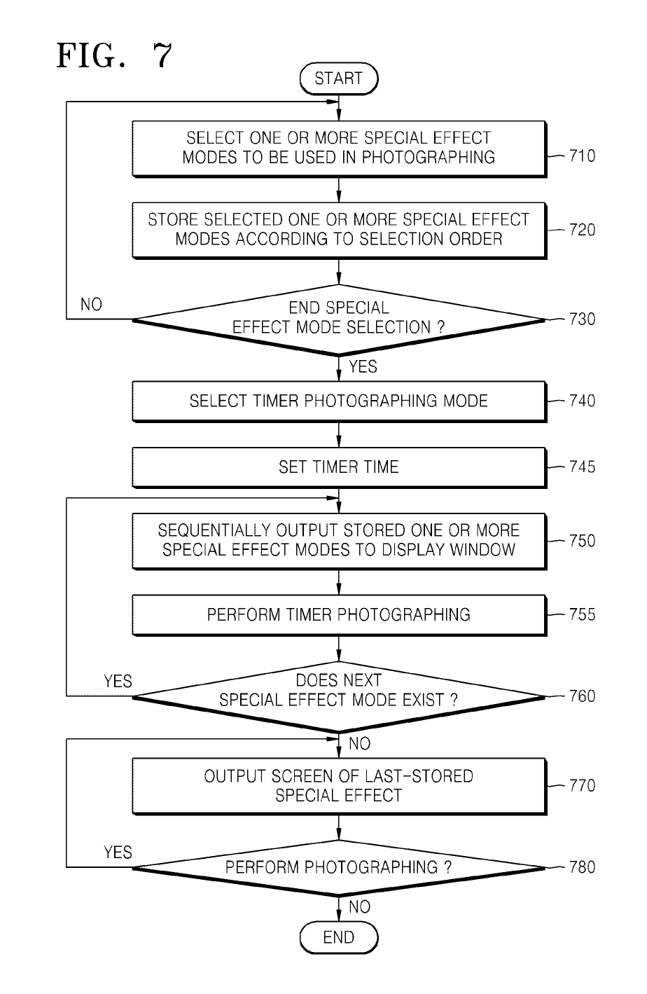

FIG. 6 is a flowchart of the photographing method of FIG. 2, according to another exemplary embodiment.

Operations 610 through 630 are the same as operations 410 through 430 of the method of FIG. 4, and thus, descriptions thereof are not provided.

According to operations 610 through 630, one or more special effect mode indicators are stored in the storage unit 120 in an order that reflects the user's order of selection.

Then, a motion-recognition photographing mode is selected from a photographing menu (operation 640). Motion-recognition technology is well understood by those familiar with this field, and so a detailed description of it is unnecessary.

When the special effect mode indicators corresponding to the user selections are stored, a special effect mode, corresponding to a first one of the stored special effect mode indicators, is output to a display window (operation 645).

Next, it is determined whether a zoom control operation has been performed via motion-recognition (operation 650).

If zoom control was performed via the motion-recognition, then zoom-in and zoom-out operations are performed via the motion-recognition (operation 655).

Then, when a photographing signal is received via the motion-recognition, a photographing operation is performed using the first special effect mode that is output to the display window (operation 660).

If the zoom control via the motion-recognition was not performed or if photographing is performed via the motion-recognition, a check is made to determine whether a next one of the stored special effect mode indicators exists (operation 665).

If the stored next special effect mode indicator exists, operations 645 through 665 are repeated so that special effect modes, corresponding to the rest of the stored special effect mode indicators, are sequentially output to the display window (operation 645), and then photographing operations are consecutively performed with the application of special effect modes according to the order of the rest of the stored special effect mode indicators (operation 660).

For example, returning now to the situation in which the user 320 previously selected, in order, the clear, fish-eye2, sepia, and smooth modes, so that indicators corresponding to these modes were stored in that order, and with reference to FIG. 3, when a first photographing motion of the user 320 is recognized, a photographing operation is performed in the clear mode that previously was first selected by the user; then, when a second photographing motion of the user 320 is recognized, a photographing operation is performed in the fish-eye2 mode that was selected and stored second; then, when a third photographing motion of the user 320 is recognized, a photographing operation is performed in the sepia mode that was selected and stored third; and then, when a fourth photographing motion of the user 320 is recognized, a photographing operation is performed in the smooth mode.

Otherwise, there are no further stored special effect mode indicators, a special effect mode corresponding to the final stored special effect mode indicators is output to the display window (operation 670).

Then, a check is made for receipt of the photographing signal (operation 680), and the special effect mode corresponding to the final one of the stored special effect mode indicators is output to the display window until photographing is finished.

Thus, according to the exemplary embodiment, whenever a photographing motion of a user is recognized, images having respective special effect modes applied may be consecutively captured according to the order of the special effect modes previously selected by the user.

FIG. 7 is a flowchart of the photographing method of FIG. 2, according to another exemplary embodiment.

Operations 710 through 730 are the same as operations 410 through 430 of the method of FIG. 4, and thus descriptions thereof are not provided.

According to operations 710 through 730, one or more special effect modes are stored in the storage unit 120 according to an order by which the one or more special effect modes are selected.

Then, a timer photographing mode is selected from a photographing menu (operation 740). Then, a timer is set (operation 745).

When the user has selected all of the desired special effects in their order, and the corresponding special effect mode indicators are all stored in the same order, a special effect mode, corresponding to the first one of the stored special effect mode indicators, is output to a display window (operation 750).

Then, when the time period set in the timer has elapsed, timer photographing is performed in a manner corresponding to the first one of the stored special effect mode indicators (operation 755).

Then, it is determined whether there are any more stored special effect mode indicators (operation 760).

If any more stored special effect mode indicators exist, then operations 750 through 760 are repeated so that the rest of the special effect modes corresponding to the stored indicators are sequentially output to the display window (operation 750), and then photographing operations are consecutively performed with special effects being applied according to the order of the rest of the stored special effect mode indicators (operation 755).

For example, as illustrated in FIG. 3, when the time period set in the timer elapses, timer is up, a photographing operation is performed in the clear mode that was selected and stored first; when the time period again elapses, a photographing operation is performed in the fish-eye2 mode that was selected and stored second; when the time period set in the timer elapses a third time, a photographing operation is performed in the sepia mode that was selected and stored third; and then, when the time period set in the timer elapses a fourth time, a photographing operation is performed in the smooth mode.

Then, if no more stored special effect mode indicators remain, a special effect mode corresponding to the final one of the stored special effect mode indicators is output to the display window (operation 770).

Then, a check is repeatedly made for a photographing signal (operation 780) during which time a special effect mode corresponding to the final one of the stored special effect mode indicators is output to the display window, until photographing is finished.

Accordingly, whenever the time period set in a timer has elapsed, images to which respective special effect modes are applied may be consecutively captured, and the special effect modes are applied according to an order of previous selection by a user.

The exemplary embodiments can be realized in a number of ways. For example, they can be realized as computer programs, and can be implemented in general-use digital computers that execute the programs using a computer-readable recording medium. In addition, a data structure used in the exemplary embodiments can be written to a computer-readable recording medium through various means. Examples of a computer-readable recording medium include physical storage devices such as magnetic storage media (e.g., ROM, floppy disks, hard disks, etc.), optical recording media (e.g., CD-ROMs, or DVDs), and the like.

While this inventive concept has been particularly shown and described with reference to exemplary embodiments thereof, it will be understood by those of ordinary skill in the art that various changes in form and detail may be made therein without departing from the inventive concept as defined by the appended claims. The exemplary embodiments should be considered in a descriptive sense only and not for purposes of limitation. Therefore, the scope of the inventive concept is to be defined not by the particulars of the detailed description, but by the appended claims, and all differences within the scope should be understood as being included.

1. A photographing method comprising:
receiving selection signals indicating one or more special effect modes to be applied to one or more photographing operations to be carried out, wherein the one or more selection signals are received in a selection order;
storing, based on the one or more selection signals, one or more stored special effect mode indicators, wherein each of the one or more stored special effect mode indicators relate to a corresponding one of the one or more special effect modes, and wherein the one or more stored special effect mode indicators are stored in an order based on the selection order of the one or more selection signals; and
consecutively performing photographing operations of the corresponding special effect modes according to an order of the stored one or more special effect mode indicators whenever a photographing signal is received.

2. The photographing method of claim 1, further comprising resetting the order of the one or more stored special effect mode indicators.

3. The photographing method of claim 21, further comprising outputting to a display window the corresponding one of the one or more special effect modes to be applied.

4. The photographing method of claim 21, wherein, after the current photographing operation is performed, an image to be captured is displayed, on a display window, using a next one of the one or more special effect modes indicated by a next one of the one or more stored special effect mode indicators.

5. The photographing method of claim 21, wherein, when, after completion of the current photographing operation in which a final one of the one or more stored special effect mode indicators has been used to identify the corresponding one of the one or more special effect modes to be applied, the corresponding one of the one or more special effect modes is caused to continue to be output to a display window.

6. The photographing method of claim 21, wherein the current photographing operation captures an image in accordance with the corresponding one of the special effect modes to be applied, in response to receiving a photographing signal, and wherein the photographing signal is generated from a photographing button operation.

7. The photographing method of claim 21, wherein the current photographing operation captures an image in accordance with the corresponding one of the special effect modes to be applied, in response to receiving a photographing signal, and wherein the photographing signal is generated from a remote controller.

8. The photographing method of claim 21, wherein the current photographing operation captures an image in accordance with the corresponding one of the special effect modes to be applied, in response to receiving a photographing signal, and wherein the photographing signal is generated when a photographing motion of a user is recognized.

9. The photographing method of claim 21, wherein the current photographing operation captures an image in accordance with the corresponding one of the special effect modes to be applied, in response to receiving a photographing signal, and wherein the photographing signal is generated in response to an indication from a timer that a previously set period of time has elapsed.

10. The photographing method of claim 21, further comprising adjusting for a distance, via zoom-in and zoom-out operations, between the completion of the current photographing operation and a next one of the one or more photographing operations.

11. The photographing method of claim 10, wherein the zoom-in and zoom-out operations are in response to a button manipulation.

12. The photographing method of claim 10, wherein the zoom-in and zoom-out operations are in response to a signal received from a remote controller.

13. The photographing method of claim 10, wherein the zoom-in and zoom-out operations are in response to a motion-recognition operation.

14. A photographing apparatus comprising:
an image processor that captures an image, generates image data of the image in accordance with a selected special effect mode, and outputs generated the image data;
a display unit that displays the generated image data, and displays an operation control menu; and
a control unit that sequentially stores one or more stored special effect mode indicators based on selections made from the operation control menu, and controls capturing of future images so as to apply special effect modes based on an order of the one or more stored special effect mode indicators, responsive to a photographing signal.

15. The photographing apparatus of claim 14, wherein the photographing signal comprises one of a button signal, a remote-control signal, a timer elapse signal, and a motion-recognition signal.

16. A computer-readable recording medium having recorded thereon a program for executing the photographing method of claim 1.

17. A photographing apparatus comprising:
a computer readable medium storing a control program that defines a plurality of operations;
a control unit that executes the plurality of operations defined by the control program;
an image capture unit, under control of the control unit; and
special effect modes applicable to captured images;
wherein the plurality of operations include:
storing a user-selected, ordered set of special effect mode indicators, the order of the special effect mode indicators defining a special effect application order, each of the special effect mode indicators having a correspondence with one of the special effect modes; and
using the image capture unit to capture images, the order in which the images are captured defining an image capture order;
wherein each of the images has applied thereto, automatically, a respective one of the special effect modes; and
wherein the respective one of the special effect modes is determined based on the special effect application order, the image capture order, and the correspondence of the special effect mode indicators with the special effect modes.

18. The photographing apparatus of claim 17, further comprising:
a display under control of the control unit;
wherein:
prior to capturing each of the images, the display displays an image capture preview;
the image capture preview is displayed on the display with one of the special effect modes applied;
the one of the special effect modes applied to the image capture preview is selected based on both the special effect application order and the image capture order.

19. The photographing apparatus as set forth in claim 18, wherein, after each of the ordered set of special effect mode indicators has been used in the capturing of the images, a final one of the ordered set of special effect mode indicators is automatically used to select a corresponding one of the special effect modes for application to the image capture preview.

20. The photographing apparatus as set forth in claim 17, wherein the capture of the images is carried out in response to photographing signals received in response to one or more of a button manipulation, a remote control transmission, a motion recognition operation, and an elapse of a period of time set in a timer.

21. The photographing method of claim 1, wherein the performing of the photographing operations comprises consecutively performing each of the one or more photographing operations so that, for a current photographing operation of the one or more photographing operations:
a next one of the one or more stored special effect mode indicators is used to identify the corresponding one of the one or more special effect modes to be applied; and
the corresponding one of the one or more special effect modes to be applied is applied to the current photographing operation.
